(19) United States
(12) Patent Application Publication
(10) Pub. No.: US 2016/0084443 A1
(43) Pub. Date: Mar. 24, 2016

(54) A PRESSURISED FLUID CONTAINER

(71) Applicant: LINDE AKTIENGESELLSCHAFT, Munich (DE)

(72) Inventors: Duncan Wales, Castor (GB); Mark Mellors, Hitchin (GB)

(21) Appl. No.: 14/890,594

(22) PCT Filed: May 20, 2014
(86) PCT No.: PCT/EP2014/060316

§ 371 Date: Nov. 12, 2015

(30) Foreign Application Priority Data
May 20, 2013 (GB) 1309042.8

(51) Int. Cl. F17C 13/04; F16K 1/30

(52) U.S. Cl. CPC F17C 13/04; F16K 1/305; F16K 1/307; F17C 2205/0323; F17C 2205/0382; F17C 2205/0394; F17C 2260/036

(57) ABSTRACT

A pressurised fluid container having a shut off valve within a valve body. The valve body contains at least one high pressure seal to seal the region around the valve. The valve body is configured such that any leakage past the or each high pressure seal enters an internal gas path which routes any fluid leakage past the or each high pressure seal to one or more discrete ports in the valve body.

The present invention relates to a pressurised fluid container having a shut-off valve.

In particular, the invention relates to a pressurised gas cylinder for use, for example, with medical gasses, welding gasses and the like.

Such cylinders are traditionally provided with a shut off valve at the top of the cylinder which is protected by a guard. The valve has a valve element which is moved towards and away from a seat by rotation of a screw mechanism. This consists of a hand wheel with a male screw which mates with a female screw thread in the valve body. The user can therefore open and close the shut off valve by rotating the hand wheel to raise and lower the valve element.

Although such mechanisms are widely used, they suffer from a number of problems. The hand wheel requires multiple rotations in order to rotate it and it is not particularly accessible when the guard is in place. Further, it can be stuck in a fully open or a fully closed position. Although arrows are usually present on the wheel to indicate the direction of opening and closing to the user, it is difficult to determine by sight the current position of the wheel, such that the user can, for example, attempt to open an already fully open valve and mistakenly believe the valve to be stuck.

A further difficulty with the fact that there is no clear indication of position is that a user may not fully close a valve as there is no clear indication that the valve has reached the fully closed position, thereby leading to inadvertent leakage from the container.

A number of these problems are overcome by using a lever in place of a hand wheel.

A lever provides good mechanical advantage and its position can provide a clear indication of the position of the valve. The lever can, in one position, be placed alongside the container such that it is reasonably well protected from damage. However, it is required to move to a second position which is generally diametrically opposed to the first position and in such a position, it would he generally vulnerable to damage as such containers are often used in harsh environments and are vulnerable to being hit, dropped or knocked over.

With a standard cylinder with a hand wheel, a regular leak detection test can be carried out typically on a daily basis to check the integrity of the valve and to check that it has been fully sealed.

The leakage detection method take the form of spraying leak detection fluid from an aerosol can onto and around the gland nut and any other external leak paths, including, for example, around the pressure gauge. If there is any leakage in the vicinity of the valve, this could cause bubbles in the leak detection fluid which provide a visual indication to the user that there is a leak problem. Whilst this can readily he done with a hand wheel, fir lever based system, this cannot he done as the significant portion of the valve mechanism is enclosed in the casing. If there is a leak around the valve, any leaking fluid may dissipate through the easing. The leak flows therefore are much more diffuse such that the leaking fluid will he spread over a much wider area and will be at a much lower flow rate making reliable detection using a spray of leak detection fluid impossible in practice.

According to the present invention there is provided a pressurised fluid container having a shut off valve within a valve body, the valve body containing at least one high pressure seal to seal the region around the valve, the valve body being configured such that any leakage past the or each high pressure seal enters an internal gas path which routes any fluid leakage past the or each high pressure seal to one or more discrete ports in the valve body.

In the present invention, the valve body channels direct any leakage to one or more discrete ports which can be readily accessible. These ports may be outlet orifices allowing the leak detection fluid to be used in the usual way. Alternatively, they may contain sensors to detect leakage. While it is possible to have more than one outlet orifice, there is no need to have more than one. Further, a single port is preferred as it provides a higher flow rate for any leak which does occur making it easier to detect.

The invention is applicable, in principle, to the hand wheel valve of the prior art, and there may be benefits associated with using the invention in this context, However, preferably, the valve comprises a valve element which is linearly moveable along a main axis towards and away from a valve seat in order to selectively open the valve, the valve further comprising a lever coupled to a rotatable shaft to rotate about a pivot axis perpendicular to the main axis, rotation of which lever about the pivot axis causes linear movement of the valve element. The valve element is preferably biased closed such that it will automatically close in the event of damage to the lever.

Preferably, the valve has a valve stern connected to the valve element, and wherein there is an inner high pressure seal surrounding the valve stem to seal the interface between the valve stem and the valve body. There is also preferably an outer high pressure seal to seal an interface between two components of the case work and preferably also low pressure seals above the or each outlet orifice to seal any potential leakage paths above the or each port.

An example of a cylinder in accordance with the present invention will now be described with reference to the accompanying drawings, in which:

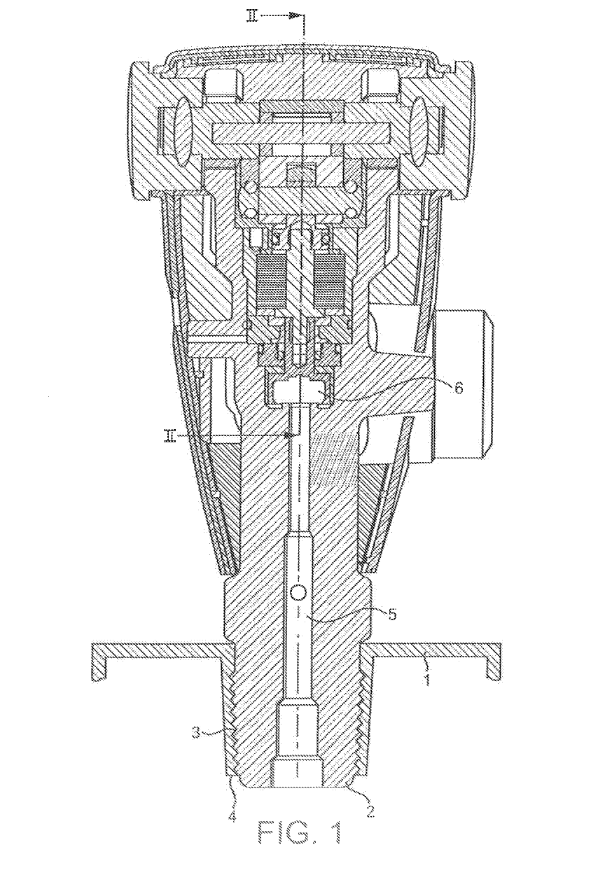

FIG. 1 is a cross section through the top of the cylinder and the valve body;

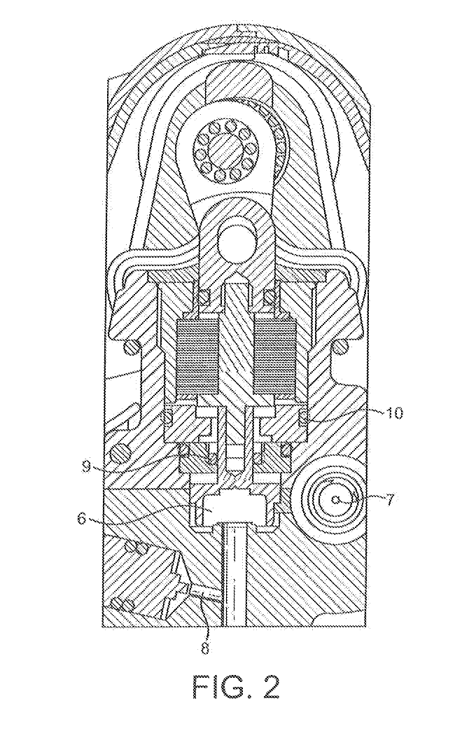

FIG. 2 is a cross section taken along lines II to II in FIG. 1;

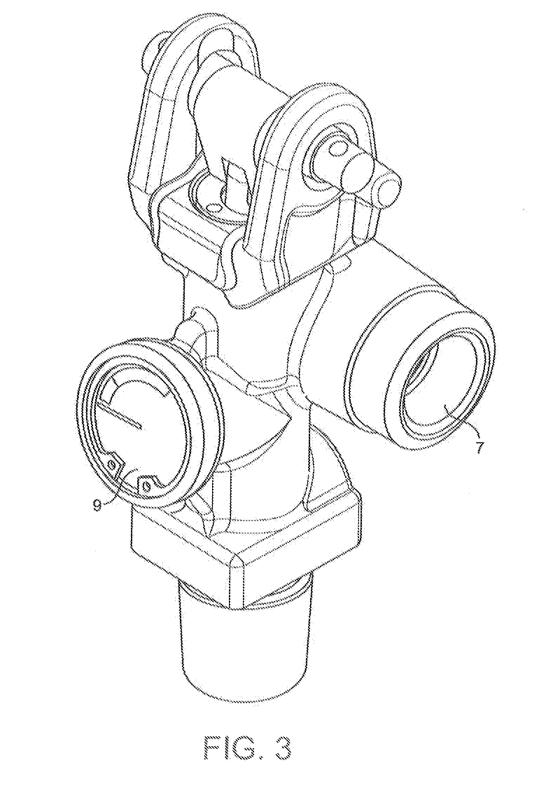

FIG. 3 is a perspective view of the valve body; and

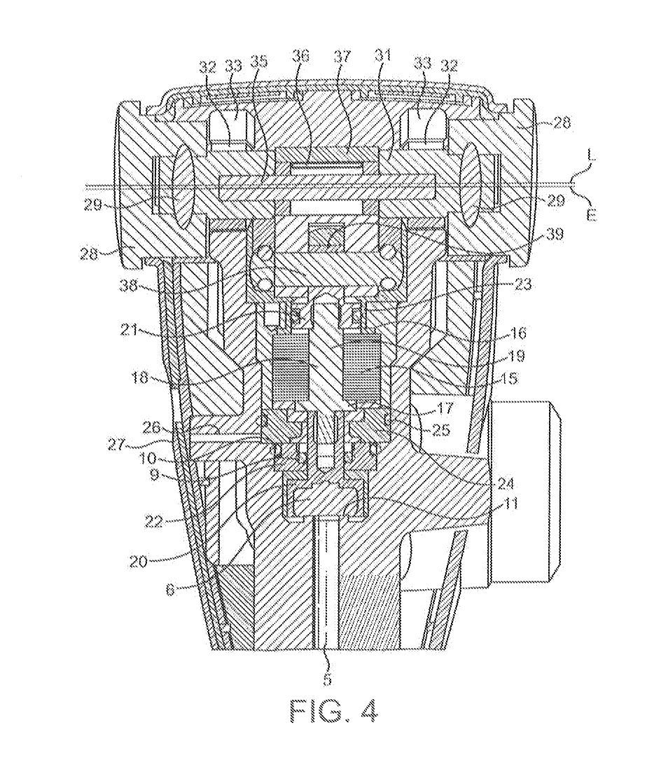

FIG. 4 shows the top portion of FIG. 1 in greater detail.

The fluid cylinder consists of a cylinder body 1 for a pressurised fluid and a valve body 2. The cylinder 1 is provided with a female screw thread 3 which mates with a male screw thread 4 on an outer surface of the lower portion of the valve body 2.

The valve body has an axial gas outlet path 5 extending centrally up through the valve body 2, Flow through the gas outlet path 5 is controlled by a valve element 6 which selectively blocks flow to a gas outlet port 7. The lateral port 8 of the pressure side of the valve element 6 leads to a pressure gauge G as is well known in the art.

The pressurised gas path is sealed above the valve element 6 by an inner 9 and outer 10 high pressure O-ring seal.

Lifting the valve element 6 from its seat 11 selectively opens and closes the gas flow path out of the cylinder. The mechanism for lifting the valve element 6 will now be described.

The valve element 6 is biased closed by a spring 15 the top end of which bears against a shoulder 16 in the valve body and the bottom of which bears against an annular flange 17 which forms part of the valve stem 18. As shown in the drawings the valve stem 18 comprises a main stem 19, a valve element retaining member 20 and a valve element coupling number 21 all of which are rigidly fixed together.

As mentioned above, the pressurised gas path is sealed by inner and outer high pressure O-ring seals 9, 10, The inner seal 9 surrounds a lower annular component 22 in the case work and seals the interface between the valve stem retaining member 20 and the lower annular component 22. The outer high pressure O-ring seal 10 seals the interface between the lower annular component and the surrounding valve body.

There is a potential leak path past each of these seals, For the inner high pressure O-ring seal 9, this leakage path can leak around the valve stem 8, but this leakage path is sealed in an upper low pressure O-ring seal 23. Instead, a vent path is provided between the lower annular component 22 and an adjacent upper annular component 24. Similarly, there is a potential leakage flow path around the outer high pressure O-ring seal 10 and, again, this is routed to a vent path between the upper and lower annular components 22, 24. The interface between the upper annular component 24 and the surrounding case work is sealed by a low pressure seal 25. As a result of this, all leakage past the inner 9 and outer 10 high pressure O-ring seals 9, 10 is routed to a gas leakage outlet orifice 26.

In order to carry out a leakage test, the user can spray detecting fluid in the vicinity of the outlet of the gas leakage outlet orifice 26 which provides a simple indication of a leakage of the pressurised cylinder without the need for removal of the casework.

In order to open the valve element 6 against the action of the spring 15, a lever mechanism is provided. This comprises a lever 27 which is connected via a pair of bosses 28 and shear pins 29 to be rotatable with a shaft 31 about fixed lever axis L. The shear pins protect the valve mechanism against unexpected forces about the lever axis L. The shaft is mounted in bearings 32 in respective bosses 33 at the top of the valve body as best shown in FIG. 4. An eccentric pin 35 forms a central portion of the shaft 31 and is mounted to rotate about an eccentric axis E off-set from lever axis L and which moves as the lever 27 is operated. A linkage member 37 is rotatably mounted to the eccentric pin 35 via pin bearings 36 and extends at its lower end to a connecting pin 38 which extends through and is coupled to an orifice 39 in the valve element coupling member 21.

This provides a crank arrangement whereupon lifting the lifting lever 27 from its at rest position shown in FIGS. 1 and 4 initially causes downward movement of the connecting pin 38 and hence the valve element, thereby compressing a spring 15. This effectively ensures that the valve is locked in the closed position as the spring force must be overcome before the valve can be opened. Once the lever 27 reaches an over-centre position, the direction of the force applied by the lever to the connecting pin 38 is reversed and this, together with the energy stored in the spring by the initial compression and the gas pressure in the cylinder causes the valve element 6 to snap open.

It should he noted that while the invention has been described in relation to this one particular configuration of a lever operated system, it is broadly applicable to any lever operated system for example as disclosed in CA 2282129.

1. A pressurised fluid container having a shut off valve within a valve body, the valve body containing at least one high pressure seal to seal the region around the valve, the valve body being configured such that any leakage past the or each high pressure seal enters an internal gas path which routes any fluid leakage past the or each high pressure seal to one or more discrete ports in the valve body.

2. A container according to claim 1, wherein the ports are outlet orifices.

3. A container according to claim 1, wherein the ports contain sensors.

4. A container according to claim 1, wherein there is a single port.

5. A container according to claim 1, wherein the valve comprises a valve element which is linearly moveable along a main axis towards and away from the valve seat in order to selectively open the valve, the valve further comprising a lever coupled to a rotatable shaft to rotate about a pivot axis perpendicular to the main axis, rotation of which lever about the pivot axis causes linear movement of the valve element.

6. A container according to claim 5, wherein the valve element is biased closed.

7. A container according to claim 5, wherein the valve has a valve stem connected to the valve element, and wherein there is an inner high pressure seal surrounding the valve stem to seal the interface between the valve stem and the valve body.

8. A container according to claim 7, wherein there is an outer high pressure seal to seal an interface between two components of the valve body.

9. A container according to claim 1, wherein there are low pressure seals above the or each port to seal any potential leakage paths above the or each port.
